(19) United States
(12) Patent Application Publication
(10) Pub. No.: US 2026/0032550 A1
(43) Pub. Date: Jan. 29, 2026

(54) METHODS AND SYSTEMS FOR DETERMINING CHANNEL BONDING GROUPS

(71) Applicant: Comcast Cable Communications, LLC, Philadelphia, PA (US)

(72) Inventors: Belal Hamzeh, Englewood, CO (US); Robert Lund, Englewood, CO (US); Jingjie Zhu, Englewood, CO (US)

(21) Appl. No.: 18/785,987

(22) Filed: Jul. 26, 2024

(51) Int. Cl. H04W 40/02; H04L 12/28; H04L 27/26

(52) U.S. Cl. CPC H04W 40/02; H04L 27/2602; H04L 12/2801

(57) ABSTRACT

Methods, apparatuses, and systems are described for determining tier based bonding groups for upstream or downstream communication between a communication device and a headend. Based on a capability of modem to implement a maximum number of channels and a user subscription level, a combination of channels may assigned to a channel bonding group. After the combination of channels are assigned to the channel bonding group, communication device resources may be allocated between the channels of the combination of channels of the channel bonding group.

### BACKGROUND

The data over cable service interface specifications (DOCSIS) 4.0, published by Cable Television Laboratories, Inc., drastically increases the upstream spectrum by more than eight-fold to 684 megahertz (MHz) and in the number of supported orthogonal frequency division multiple access (OFDMA) channels to a minimum of seven OFDMA channels. This is an improvement in comparison to DOCSIS 3.1 that supported up to 204 MHz in high-split and two OFDMA channels. However, increased upstream path-loss when operating at higher upstream frequencies while maintaining the same maximum modem transmit power from the DOCSIS 3.1 PHY specification could potentially result in a lower received power spectral density at the remote physical-layer device (RPD) burst receiver. This in turn translates to lower modulation orders and reduced spectral efficiency.

### SUMMARY

It is to be understood that both the following general description and the following detailed description are examples and explanatory only and are not restrictive. Methods, systems, and apparatuses for determining tier-based channel bonding groups for upstream or downstream communications between a communication device and a headend are described.

A cable modem termination system (CMTS or vCMTS) may be configured to assign a combination of channels to a channel bonding group for transferring data upstream/downstream between the cable modem and a headend. A plurality of channels for a combination path (e.g., an upstream or a downstream communication path) associated with a cable modem may be determined. Each channel of the plurality channels may comprise a frequency range of a plurality of frequency ranges. Based on a capability of modem to implement a maximum number of channels and a user subscription level associated with the cable modem, a combination of channels may be assigned to a channel bonding group associated with the communication path. After the combination of channels are assigned to the channel bonding group, cable modem resources may be allocated between the channels of the combination of channels of the channel bonding group.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for determining channels for a bonding group;

FIG. 2 shows an example of upstream and downstream channels;

FIG. 3 shows example bonding groups;

FIG. 4 shows an example upstream reference power spectral density;

FIG. 5 shows an example bonding process;

FIG. 6 shows an example bonding group recommendation;

FIG. 7 shows an example bonding group recommendation;

FIG. 8 shows a flowchart of an example method;

FIG. 9 shows a flowchart of an example method;

FIG. 10 shows a flowchart of an example method; and

FIG. 11 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

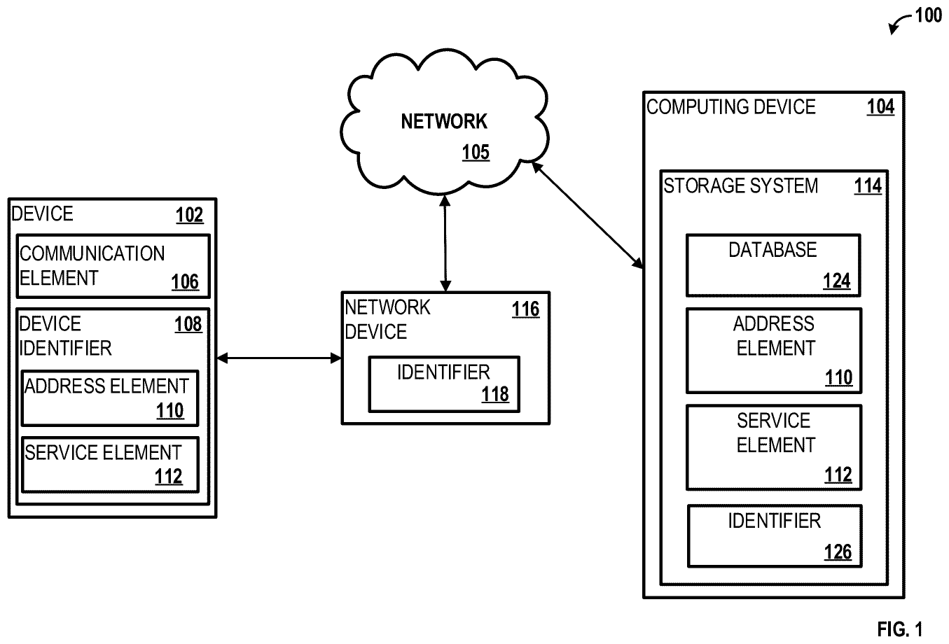

FIG. 1 shows an example system 100 for determining a combination of channels to assign to a channel bonding group for upstream or downstream communications between a communication device (e.g., a cable modem) and a headend. For example, the system 100 may be configured to determine a capability of a communication device (e.g., cable modem) to implement a maximum number of channels and a user subscription level associated with the communication device. Based on the determination, the system 100 may assign a combination of channels to a channel bonding group for the upstream or downstream communications between the communication device and the headend. The network and system 100 may be configured to provide services, such as network-related services, to a device (e.g., device 102). The system 100 may comprise a device 102 in communication with a network device 116, such as a wireless access point (e.g., gateway device, cable modem, etc.). The computing device 104 may be disposed locally or remotely relative to the device 102. The network device 116 may facilitate access to the network 105 for the device 102 and/or the computing device 104. For example, the device 102 and the computing device 104 may be in communication via a private and/or public network 105 such as the Internet or a local area network (LAN) via the network device 116. The network device 116 may be in communication with a computing device 104 such as a centralized device or a server, for example. Other forms of communications can be used such as wired and wireless telecommunication channels.

The device 102 may comprise electronic devices such as a computer, a smartphone, a laptop, a tablet, a set top box, a display device, a printer, a telephone, a network device, a communication terminal, a transmitter, or other device capable of communicating with the network device 116. As an example, the device 102 may comprise a communication element 106 for offering an interface to a user to interact with the device 102 and/or the computing device 104. The communication element 106 can be any interface for presenting and/or receiving information to/from the user, such as media content. An example interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the device 102 and/or the network device 116. As an example, the communication element 106 can request or query various files from a local source and/or a remote source. As an example, the communication element 106 can transmit data to a local or remote device such as the network device 116 or the computing device 104 via the network device 116.

The device 102 may be associated with a user identifier or a device identifier 108. As an example, the device identifier 108 may be any identifier, token, character, string, or the like, for differentiating one user or user device (e.g., device 102) from another user or user device. The device identifier 108 may identify a user or user device as belonging to a particular class of users or user devices. As an example, the device identifier 108 may comprise information relating to the user device such as a manufacturer, a model or type of device, a service provider associated with the device 102, a state of the device 102, a locator, and/or a label or classifier. Other information can be represented by the device identifier 108.

The device identifier 108 may comprise an address element 110 and a service element 112. The address element 110 may comprise or make available an internet protocol address, a network address, a media access control (MAC) address, an Internet address, or the like. As an example, the address element 110 may be relied upon to establish a communication session between the device 102 and the network device 116 or other devices and/or networks. As an example, the address element 110 may be used as an identifier or locator of the device 102. The address element 110 may be persistent for a particular network.

The service element 112 may comprise identification of a service provider associated with the device 102 and/or with the class of the device 102. The class of the device 102 may be related to a type of device, a capability of a device, a type of service being offered, and/or a level of service (e.g., a business class, a service tier, a service package, etc.). As an example, the service element 112 may comprise information relating to or made available by a communication service provider (e.g., an Internet service provider) that is offering or enabling data flow such as communication services to the device 102. As an example, the service element 112 may comprise information relating to a preferred service provider for one or more particular services relating to the device 102. The address element 110 may be used to identify or retrieve data from the service element 112, or vice-versa. As an example, one or more of the address element 110 and the service element 112 can be stored remotely from the device 102 and retrieved by one or more devices such as the device 102 and the computing device 104. Other information can be represented by the service element 112.

The network device 116 may be in communication with a network, such as network 105. The network device 116 may be configured to allow one or more wireless devices to connect to a wired and/or wireless network using Wi-Fi, Bluetooth®, Zigbee®, or any desired method or standard. As an example, the network device 116 may be configured to facilitate the connection of a device, such as the device 102, to the network 105 (e.g., in-home network, and/or a provider's wireless, coaxial, fiber, or hybrid fiber/coaxial distribution system such as a DOCSIS network). The network device 116 may be configured as a communication device such as a cable modem, a set top box, a wireless access point (WAP), a gateway device, a combination thereof, or any device capable of providing content and/or Internet services to a user device (e.g., device 102). In an example, the network device 116 may be configured as a set top box configured to output content items to a display device (e.g., devices 102). In an example, the network device 116 may be configured as a WAP, a gateway device, and/or cable modem to provide access to a wide area network (e.g., the Internet). For example, the network device 116 may be configured to access the wide area network via a computing device (e.g., computing device 104, server, headend, Internet service provider, etc.). In an example, the network device 116 may be configured to perform one or more gateway and/or cable modem functions in order to provide the access to the wide area network. The one or more gateway functions may comprise one or more of network traffic routing, dynamic host configuration protocol (DHCP) management, VOIP functions, or IP streaming functions. In an example, the network device 116 may be configured as a local network (e.g., local area network (LAN)) to provide, to the device 102 access to the wide area network via the local network.

The network device 116 may comprise an identifier 118. As an example, one or more identifiers can be or relate to an Internet Protocol (IP) Address IPV4/IPV6 or a media access control address (MAC address) or the like. As a further example, the identifier 118 may be unique identifiers for facilitating communications on the physical network segment. Each of the network device 116 may comprise an identifier 118 that is distinct. As an example, the identifier 118 may be associated with a physical location of the network device 116.

The network device 116 (e.g., communication device, cable modem, gateway device, wireless access point, etc.) may be configured to operate according to the DOCSIS standard. For example, the network device 116 may be configured to transfer data based on one or more upstream channels (e.g., frequencies) and/or one or more downstream channels (e.g., frequencies) between a headend device and the network device 116. As an example, the network device 116 may aggregate (e.g., combine) multiple upstream or multiple downstream channels into one or more channel bonding groups, and thus, create a single large pipe for data traffic transfer between the headend and the network device 116, which in-turn may increase capacity available to the network device 116 for transferring data. In addition to increasing upstream/downstream capacity, bonding groups may enable load balancing across multiple channels, and thus, may reduce the possibility of channel congestion and may provide additional reliability through redundancy as the network device 116 may not have to depend on a single communication. Thus, bonding groups may be formed (e.g., determined) to maximize capacity available to the network device 116. However, increased upstream path-loss when operating at higher upstream frequencies while maintaining the same maximum network device 116 transmit power based on the DOCSIS 3.1 PHY specification of 65 dBmV could result in a lower received power spectral density at the remote physical-layer device (RPD) burst receiver, which may translate to lower modulation orders, reduced spectral efficiency, and sub optimal capacity. For example, the network device 116 may operate to utilize all available channels to form a bonding group for transferring data resulting in a decreased power spectral density across all channels. To avoid this issue, with the introduction of DOCSIS 4.0, upstream/downstream DOCSIS 4.0 bonding groups may be formed based on a service tier (e.g., 3 Gbps, 2 Gbps, 1 Gbps, etc.) of which the network device 116 is subscribed to. For example, the network device 116 may be configured to aggregate (e.g., determine) a subset of the available channels into a channel bonding group for upstream/downstream communications in order to increase the spectral efficiency of the upstream/downstream channels.

In an example, the network device 116 (e.g., communication device, cable modem, gateway device, wireless access point device, etc.) may be configured to cause a combination of channels of the available channels to be assigned to a communication path based on a maximum number of channels the network device 116 is capable of using and a minimum number of channels required to be used by the network device 116 to provide a throughput associated with a subscription level (e.g., 3 Gbps, 2 Gbps, 1 Gbps, etc.) associated with the user account information associated with the network device 116. For example, the network device 116 may determine a plurality of channels available for a communication path associated with the network device 116. The communication path may comprise an upstream communication path or a downstream communication path. The communication path may be associated with a channel bonding group that includes multiple channels for transferring data based on the communication path. Each channel of the plurality of channels may comprise a frequency range of a plurality of frequency ranges. A combination of channels of the plurality of channels may be assigned to the communication path based on a capability of the network device 116 and user account information associated with the network device 116. For example, one or more of the plurality of channels may be assigned to the channel bonding group for transferring data between the network device 116 and a headend. As an example, the network device 116 may determine a maximum number of channels the network device 116 is capable of using and a minimum number of channels required to be used by the network device 116 to provide services (e.g., throughput such as 3 Gbps services, 1 Gbps services, etc.) associated with a subscription level associated with the user account information. The combination of channels of the plurality of channels may be assigned to the communication path based on the maximum number of channels and the minimum number of channels. For example, a ratio of a total power level capability of the network device 116 divided by target power levels per channel of the maximum number of channels may be determined. The combination of channels of the plurality of channels may be assigned to the communication path based on the ratio and based on the minimum number of channels.

In an example, the network device 116 (e.g., communication device, cable modem, gateway device, wireless access point device, etc.) may be configured to cause a combination of channels of the available channels to be assigned to a communication path based on characteristics associated with one or more combinations of channels of the plurality of channels. For example, a required capacity for the communication path may be determined based on the user account information associated with the network device 116. For example, one or more users of the network device 116 may be subscribed to one or more service tiers (e.g., service level such as 3 Gbps, 2 Gbps, 1 Gbps, etc.) for transferring data between the network device 116 and the headend. The service tier associated with the network device 116 may be determined based on the user account information associated with the network device 116. In addition, the network device 116 may determine one or more combinations of channels of the plurality of channels. For example, the network device 116 may determine a combination of channels associated with the 108-300 MHz frequency range, the 300-492 MHz frequency range, the 300-684 MHz frequency range, etc. The network device 116 may determine one or more characteristics for each combination of channels of the one or more combinations of channels. The one or more characteristics may comprise one or more of a number of channels, a bandwidth, a maximum capacity, capacity usage, an available capacity, or a conditional bonding capacity. Based on the required capacity for the communication path and based on the one or more characteristics associated with the one or more combinations of channels, the network device 116 may cause the combination of channels of the one or more combinations of channels to be assigned to the communication path. For example, each combination of channels may at least comprise a total capacity that may be compared to the required capacity for the communication path. Each combination of channels that does not have a total capacity that is equal to, or greater than, the required capacity may not need to be considered. The network device 116 may determine the combination of channels from the remaining combinations of channels based on one or more of the other characteristics. For example, the remaining characteristics may be considered (e.g., weighted) based on one or more metrics. For example, one or more metrics may be optimized for upstream or downstream communications from the network device 116 to the headend. In one example, computing overhead and/or performance may be optimized for upstream communications from the network device 116 to the headend. The combination of channels may be further determined based on one or more characteristics that best optimize computing overhead and/or performance for upstream communications. In another example, received power at the network device 116 may be optimized for downstream communications from the headend to the network device 116. The combination of channels may be further determined based on one or more characteristics that best optimize received power for downstream communications.

One or more resources of the network device 116 (e.g., communication device, cable modem, gateway device, wireless access point device, etc.) may be allocated per channel of the combination of channels assigned to the communication path (e.g., channel bonding group). The one or more resources may comprise one or more of power, computing resources, or data throughput. As an example, if multiple channel bonding groups prioritize the use of a first channel (e.g., a first frequency range), then the first channel may have a high utilization relative to the remaining channels (e.g., remaining frequency ranges). Load balancing may be applied to the channel bonding group in order to allocate the network device's 116 resources amongst the channels of the channel bonding group. For example, a baseline bit-loading for each channel may be initially determined. For example, bit-loading of a channel may represent an efficiency of a channel (e.g., N bits per symbol). As an example, higher bit-loadings may indicate that each symbol may carry more information in the number of bits (e.g., going from 8 bits to 10 bits may result in a 25% increase in efficiency). In an example, mean bit-loadings may be calculated from each subcarrier's bit-loading of all of the channels in a channel bonding group. Conditional bit-loadings of each channel may be determined (e.g., calculated) when one or more network devices 116 are bonded to each of one or more configured bonding groups. The conditional bit-loadings may be defined as a mean bit-loading when a network device 116 is expected to bond to a set of channels. For example, the conditional bit-loading may be determined (e.g., calculated) based on a channel bonding group size (e.g., number of channels in a bonding group) and a frequency range. Next, one or more provisioning rates (e.g., service tiers) of the one or more network devices 116 may be determined. The one or more network devices 116 may be sorted according to usages/activity levels of the network devices 116 in descending order and according to the provisioning rates of the network devices 116 in ascending order. For each network device 116 of the one or more network devices 116, based on the corresponding network device's 116 conditional bit-loadings of each channel bonding group of one or more channel bonding groups, channel bonding groups of the one or more channel bonding groups may be filtered that satisfy a peak capacity requirement from the provisioning rate. Next, the filtered channel bonding groups may be sorted based on a channel bonding group size in ascending order and a current utilization allocation in ascending order. The first channel bonding group in the sorted channel bonding group list may represent the minimum-sized bonding group that has the most available bandwidth resource in the same size category. The network device's 116 utilization demand/activity level factor may be water-filled (e.g., optimal power allocation among the channels in the channel bonding group) to the first channel bonding group. The process may be iterated through all of the network devices 116 of the one or more network devices 116 until the load balancing is optimized for each network device 116.

The computing device 104 may comprise a server (e.g., headend), or a centralized device, for communicating with the network device 116, or the device 102 via the network device 116. In an example, the computing device 104 may communicate with the device 102 for offering data and/or services. For example, the computing device 104 may offer services such as network (e.g., Internet) connectivity, network printing, media management (e.g., a media server), interference management, content services, streaming services, broadband services, or other network-related services. The computing device 104 may be configured to operate according to the DOCSIS standard. For example, the computing device 104 may be configured to transfer data based on one or more upstream channels (e.g., frequency ranges) and/or one or more downstream channels (e.g., frequency ranges) between the computing device 104 and one or more communication devices (e.g., network devices 116, cable modems, gateway devices, wireless access points, etc.).

The computing device 104 may allow the device 102 to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The storage system 114 may store information relating to the device 102 such as the address element 110 and/or the service element 112. As an example, the computing device 104 may obtain the device identifier 108 from the device 102 and retrieve information from the storage system 114 such as the address element 110 and/or the service element 112. As a further example, the computing device 104 may obtain the address element 110 from the device 102 and may retrieve the service element 112 from the storage system 114, or vice versa. Any information can be stored in and retrieved from the storage system 114. The storage system 114 can be disposed remotely from the computing device 104 and accessed via direct or indirect connection. The storage system 114 can be integrated with the computing device 104 or some other device or system.

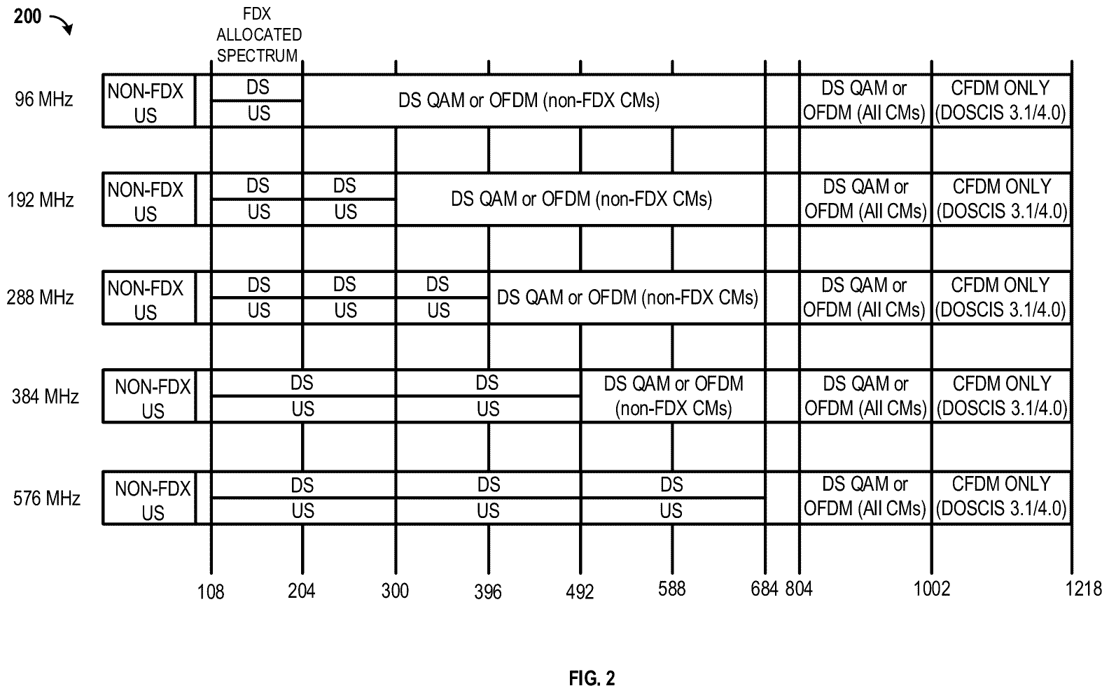

FIG. 2 shows an example of upstream and downstream channels 200 according to DOCSIS 4.0. DOCSIS 4.0 introduces support for multiple gigabits per second (Gbps) symmetric services by extending both the upstream and downstream supported capacities through an increase in the number of supported downstream and upstream OFDM/OFDMA channels in comparison to DOCSIS 3.1 as shown in Table 1 below:

TABLE 1
CM/CMTS Capability Comparisons

| | | | Cable Modem Termination | |
|---|---|---|---|---|
| | Cable Modem (CM) | | System (CMTS) Supported | |
| | Supported Channels | | Channels | |
| | DOCSIS 3.1 | DOCSIS 4.0 | DOCSIS 3.1 | DOCSIS 4.0 |
| Downstream | 2 OFDM | 5 OFDM | 2 OFDM | 6 OFDM |
| Channels | 32 SC-QAM | 32 SC-QAM | 32 SC-QAM | 32 SC-QAM |
| Upstream | 2 OFDMA | 7 OFDMA | 2 OFDMA | 8 OFDMA |
| Channels | 8 SC-QAM | 4 SC-QAM | 8 SC-QAM | 4 SC-QAM |

To support the additional downstream and upstream OFDM/OFDMA channels, DOCSIS 4.0 introduces an updated spectrum plan which extends the upstream spectrum to up to 684 MHz and allows overlapping of the upstream and downstream channels in the 108-684 MHz band for Full Duplex DOCSIS (FDX) or extends the downstream spectrum up to 1.8 GHz for Extended Spectrum DOCSIS, as shown in FIG. 2. The extension of the upstream band up to 684 MHz represents an 8-time increase in the available upstream spectrum in comparison to a mid-split (5-85 MHz) DOCSIS 3.1 system. FDX DOCSIS 4.0 enables efficient spectrum utilization by supporting concurrent operation of the upstream and downstream channels in the same band (108-684 MHz), as shown in FIG. 2, while maintaining traditional upstream operations in the legacy part of the upstream band and maintaining backward compatibility with DOCSIS 3.0 and DOCSIS 3.1 devices.

DOCSIS 3.1 supports an upstream total composite power (TCP) of 65 decibels relative to one millivolt (dBmV). However, despite an 8-time increase in the upstream spectrum, the TCP in DOCSIS 4.0 remains fixed at 65 dBmV, which is the same value that was mandated in the DOCSIS 3.1 PHY Specification. In addition, the DOCSIS 4.0 specifications define a set of rules governing the operation of the upstream TCP across both the FDX and legacy bands. For example, an FDX communication device (e.g., network device 116, cable modem, gateway device, wireless access point, etc.) must be capable of transmitting a TCP of 65 dBmV, must be capable of transmitting a total average output power of 64.5 dBmV in the FDX band, may be capable of transmitting a total average output power greater than 64.5 dBmV in the FDX band, and/or must be capable of transmitting a total average output power of 55 dBmV in the legacy US band when operating in FDX mode. To maximize upstream capacity and efficiency, upstream transmit power management in FDX DOCSIS needs to consider several factors when determining the optimum upstream transmit power. For example, a high upstream received signal level in the FDX band is desired at the remote physical-layer device to optimize the performance of the echo canceller at the receiver, maximize the modulation error ratio of the upstream signal, and support higher bit-loading in the upstream. However, at the same time, maximizing the upstream transmit power in the FDX band can potentially limit the available power for the upstream transmissions in the legacy band, and thus, reduce the achievable bit-loading in the upstream. For example, a high upstream transmit power level at the communication device can potentially increase the communication device-to-communication device interference across transmission groups, which in turn can potentially increase interference at adjacent communication devices, and thus, reduce the downstream modulation error ratio and achievable bit-loading in the downstream.

Currently, the maximum TCP of DOCSIS 4.0 devices is 65 dBmV, which is shared across the upstream FDX and legacy bands. Upstream TCP in the mid-split band exceeding 55 dBmV would require operation in the upstream FDX band at a TCP less than 64.5 dBmV. Approximately 50% of the DOCSIS 3.1 devices operate with an upstream transmit power exceeding 55 dBmV. To maintain the performance of the mid-split upstream band, this would require a reduction in the available power in the FDX band. For example, maintaining a 63 dBmV upstream TCP in the mid-split band requires a reduction of 3.8 dB of TCP in the FDX band to 60.7 dB. To maximize the upstream performance in the FDX band, it is beneficial for communication devices to be able to operate at 64.5 dBmV. This requires limiting the TCP in the upstream legacy band to 55 dBmV. With 50% of the devices operating at a TCP exceeding 55 dBmV in the mid-split upstream band, limiting their upstream TCP to 55 dBmV correlates to a reduction in upstream power spectral density (PSD) which translates to a reduction in spectral efficiency in the mid-split band.

Reducing the number of channels that are aggregated for a channel bonding group based on provisioning service tiers associated with a communication device (e.g., network device 116, cable modem, gateway device, wireless access point, etc.) may provide improve efficiency in managing upstream TCP of a communication device. Comparing the maximum upstream PSD between DOCSIS 3.1 and DOCSIS 4.0, the maximum PSD in a DOCSIS 3.1 device is approximately 47 dBmV/1.6 MHz, while for a DOCSIS 4.0 device with the upstream band operating up to 684 MHZ, maximum PSD would be 38 dBmV/1.6 MHz in the mid-split band, and 39 dBmV/1.6 MHz in the FDX band (assuming no tilt in the upstream transmit PSD in both cases for simplification). The limitations on the available upstream TCP for DOCSIS 4.0 communication devices (e.g., network devices 116, cable modem, gateway device, wireless access point, etc.) translates to approximately a 9 dB loss in upstream maximum PSD in DOCSIS 4.0 devices in comparison to a DOCSIS 3.1 device. Thus, upstream DOCSIS 4.0 channel bonding groups may be formed based on a service tier associated with a communication device (e.g., network device 116, cable modem, gateway device, wireless access point, etc.). As a result, the communication device would not need to bond across all the upstream/downstream channels available to it. This can be achieved via Dynamic Bonding Change (DBC) messaging to add only a subset of the FDX band channels to the communication device's Transmit Channel Set (TCS) (e.g., aggregated channels for the channel bonding group) once DOCSIS 3.1 registration has completed. For example, the communication device may aggregate (e.g., combine) multiple upstream or multiple downstream channels into one or more bonding groups, and thus, create a single large pipe for data traffic transfer between the headend and the communication device, which in-turn may increase capacity available to the communication device for transferring data.

In an example, the communication device (e.g., network device 116, cable modem, gateway device, wireless access point, etc.) may be configured to cause a combination of channels of the available channels to be assigned to a communication path based on a maximum number of channels the communication device is capable of using and a minimum number of channels required to be used by the communication device to provide a throughput associated with a subscription level (e.g., 3 Gbps, 2 Gbps, 1 Gbps, etc.) associated with the user account information. The communication device may determine a plurality of channels available for a communication path associated with a communication device. The communication path may comprise an upstream communication path or a downstream communication path. The communication may be associated with a channel bonding group that includes multiple channels for transferring data based on the communication path. Each channel of the plurality of channels may comprise a frequency range of a plurality of frequency ranges. A combination of channels of the plurality of channels may be assigned to the communication path based on a capability of the communication device and user account information associated with the communication device. For example, one or more of the plurality of channels may be assigned to the channel bonding group for transferring data between the communication device and a headend. As an example, the communication device a maximum number of channels the communication device is capable of using and a minimum number of channels required to be used by the communication device to provide services (e.g., throughput such as 3 Gbps services, 1 Gbps services, etc.) associated with a subscription level associated with the user account information. The combination of channels of the plurality of channels may be assigned to the communication path based on the maximum number of channels and the minimum number of channels. For example, a ratio of a total power level capability of the communication device divided by target power levels per channel of the maximum number of channels may be determined. The combination of channels of the plurality of channels may be assigned to the communication path based on the ratio and based on the minimum number of channels.

In an example, the communication device (e.g., network device 116, cable modem, gateway device, wireless access point, etc.) may be configured to cause a combination of channels of the available channels to be assigned to a communication path based on characteristics associated with one or more combinations of channels of the plurality of channels. For example, a required capacity for the communication path may be determined based on the user account information associated with the communication device. For example, one or more users of the communication device may be subscribed to one or more service tiers (e.g., service level such as 3 Gbps, 2 Gbps, 1 Gbps, etc.) for transferring data between the communication device and the headend. The service tier associated with the communication device may be determined based on the user account information associated with the communication device. In addition, the communication device may determine one or more combinations of channels of the plurality of channels. For example, the communication device may determine a combination of channels associated with the 108-300 MHz range, the 300-492 MHz range, the 300-684 MH range etc. The communication device may determine one or more characteristics for each combination of channels of the one or more combinations of channels. The one or more characteristics may comprise one or more of a number of channels, a bandwidth, a maximum capacity, capacity usage, an available capacity, or a conditional bonding capacity. Based on the required capacity for the communication path and based on the one or more characteristics associated with the one or more combinations of channels, the communication device may cause the combination of channels of the one or more combinations of channels to be assigned to the communication path. For example, each combination of channels may at least comprise a total capacity that may be compared to the required capacity for the communication path. Each combination of channels that does not have a total capacity that is equal to, or greater than, the required capacity may not need to be considered. The communication device may determine the combination of channels from the remaining combinations of channels based on one or more of the other characteristics. For example, remaining characteristics may be considered (e.g., weighted) based on one or more metrics. For example, one or more metrics may be optimized for upstream or downstream communication from the communication device to the headend. In one example, computing overhead and/or performance may be optimized for upstream communications from the communication device to the headend. The combination of channels may be further determined based on one or more characteristics that best optimize computing overhead and/or performance for upstream communications. In another example, received power at the communication device may be optimized for downstream communications from the headend to the communication device. The combination of channels may be further determined based on one or more characteristics that best optimize received power for downstream communications.

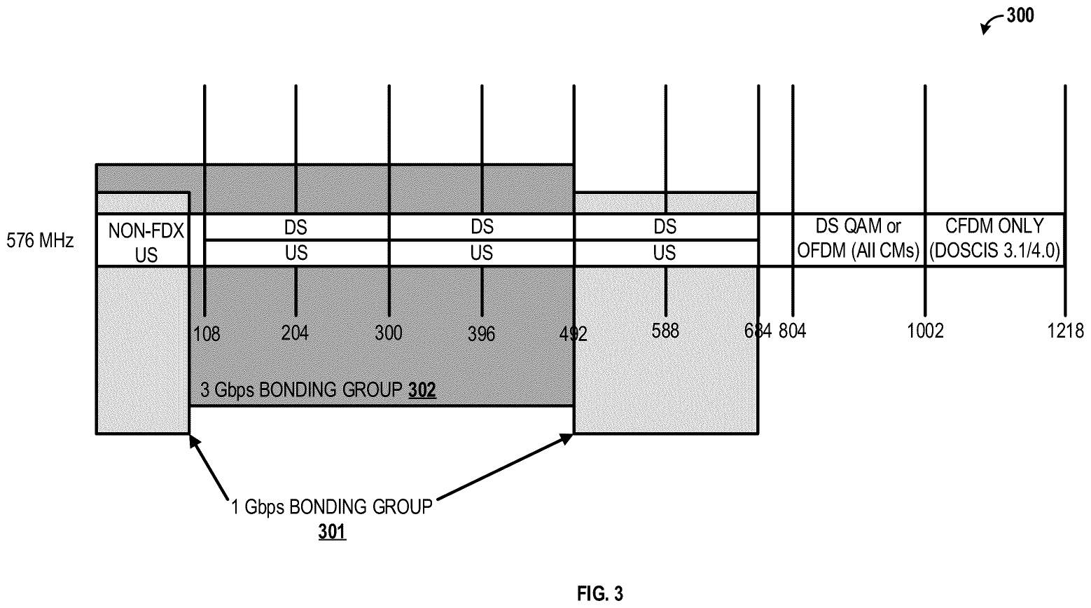

FIG. 3 shows example bonding groups 300 that may result from aggregating channels into a channel bonding group. As shown in FIG. 3, in a DOCSIS 4.0 network where the upstream band extends from 108 to 684 MHZ, a communication device (e.g., network device 116, cable modem, gateway device, wireless access point, etc.) that is subscribed to a 3 Gbps symmetric service may have a bonding group 302 comprised of the channels in the mid-split band, in addition to the first two sub-bands in the FDX band. In another example, a communication device that is subscribed to a 1 Gbps symmetric service may have a bonding group comprised of the legacy band and the last sub-band (e.g., 492 MHz to 684 MHZ) in the FDX band. Intelligent selection for the number of upstream/downstream channels for which a communication device transfers data between the communication device and a headend may enable flexibility in how power can be allocated across the FDX band and the legacy upstream band.

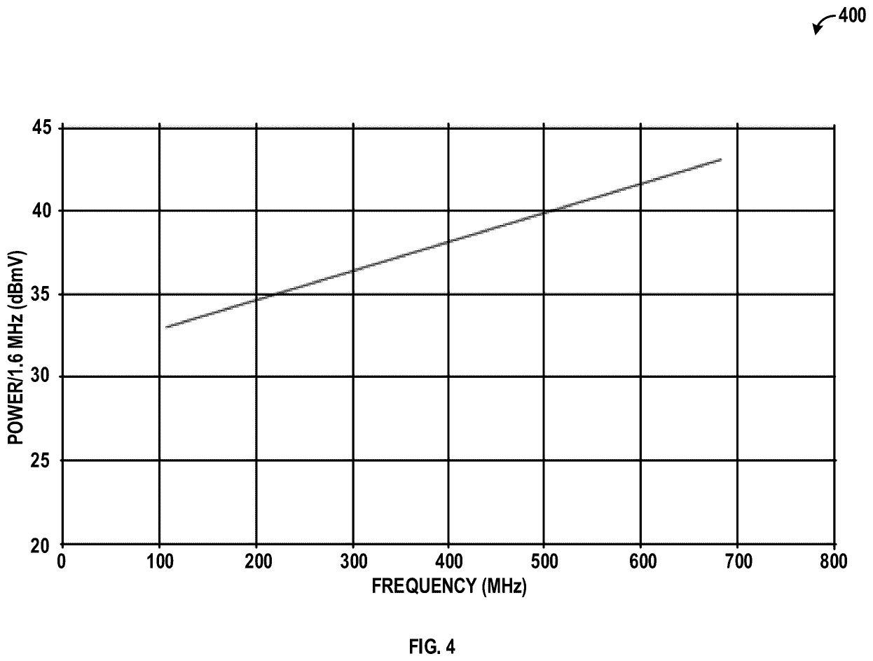

FIG. 4 shows an example upstream reference power spectral density (PSD) 400 in the FDX band. As shown in FIG. 4, DOCSIS 4.0 defines a reference upstream PSD for DOCSIS 4.0 devices which is defined as a line in dB for the y-axis and linear frequency in the x-axis, and passes through the points 33.0 dBmV in 1.6 MHz centered at 108.8 MHz and 43.0 dBmV centered at 683.2 MHz. This equates to a total power of 64.5 dBmV in the FDX band. Table 2 below provides an example for a total composite power based on upstream channels in the FDX spectrum configuration of 576 MHz, as shown in FIG. 4.

TABLE 2
Impact of Aggregated Channel Bandwidth on Total Composite Power
FDX Spectrum TCS Bandwidth

| 192 MHz | | | 384 MHz | | |
|---|---|---|---|---|---|
| Aggregated | | | Aggregated | | |
| Channels | | dB | Channels | | dB |
| in FDX | | Savings | in FDX | | Savings |
| Spectrum | TCP | rel/576 MHz | spectrum | TCP | rel/576 MHz |
| 108-300 MHz | 55.6 | 8.9 | 108-492 MHz | 60.6 | 3.9 |
| 300-492 MHz | 58.9 | 5.6 | 108-300 & | 63.1 | 1.4 |
| | | | 492-684 MHz | | |
| 492-684 MHz | 62.3 | 2.2 | 300-684 MHz | 63.9 | 0.8 |

As an example, if a communication device (e.g., network device 116, cable modem, gateway device, wireless access point, etc.) that is subscribed to a 1 Gbps service has aggregated channels in the FDX band comprising of the 3 sub-bands shown in FIG. 3 in addition to the legacy mid-split channel, then its maximum total composite power would align with the reference power spectral density shown in FIG. 4. The communication device would be limited to a maximum total composite power of 55 dBmV in the mid-split band and 64.5 dBmV across the FDX band. However, if the aggregated channels comprise the middle sub-band (e.g. 300-492 MHz) in addition to the mid-split band, then the total composite power for the communication device would be 60.4 dBmV (assuming a TCP of 55 dBmV in the mid-split band), leaving 4.6 dB of TCP headroom below Pmax (e.g., maximum power). This may provide flexibility for the communication device to transmit at higher levels in either or both bands. For example, the communication device may transmit at a total composite power of 61 dBmV in the mid-split band and a total composite power of 62.8 dBmV in the second FDX sub-band (e.g., 300-492 MHz) for a total of 65 dBmV. In addition, enabling communication devices to transmit at higher levels by reducing the number of aggregated channels for including in a channel bonding group may allow driving higher spectral efficiencies, may overcome excessive path loss, and may maximize system capacity without exceeding the communication devices' maximum total composite power of 65 dBmV.

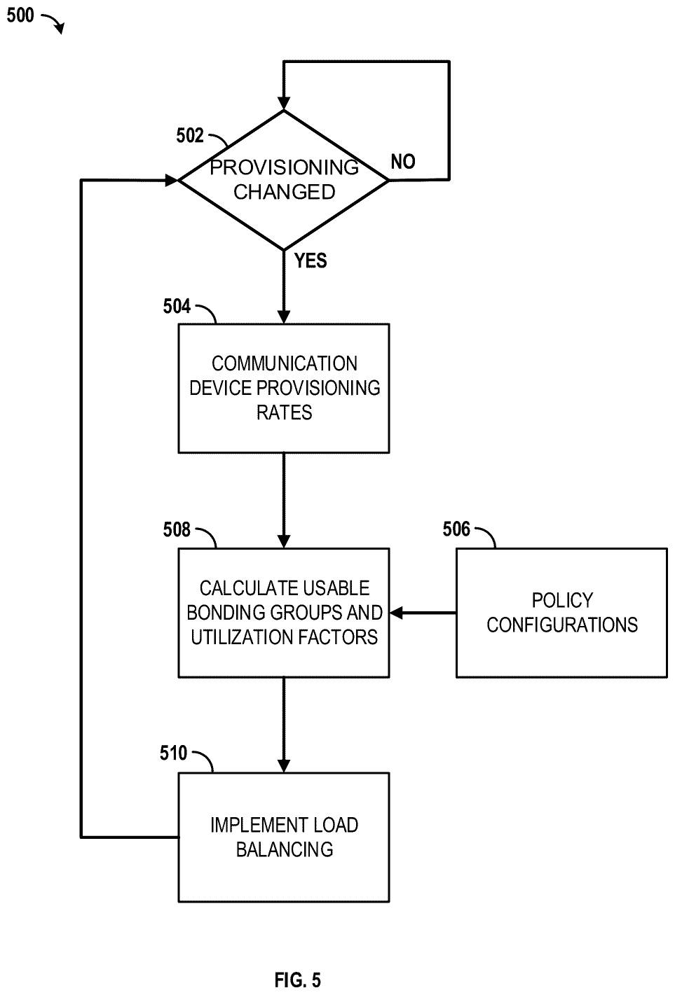

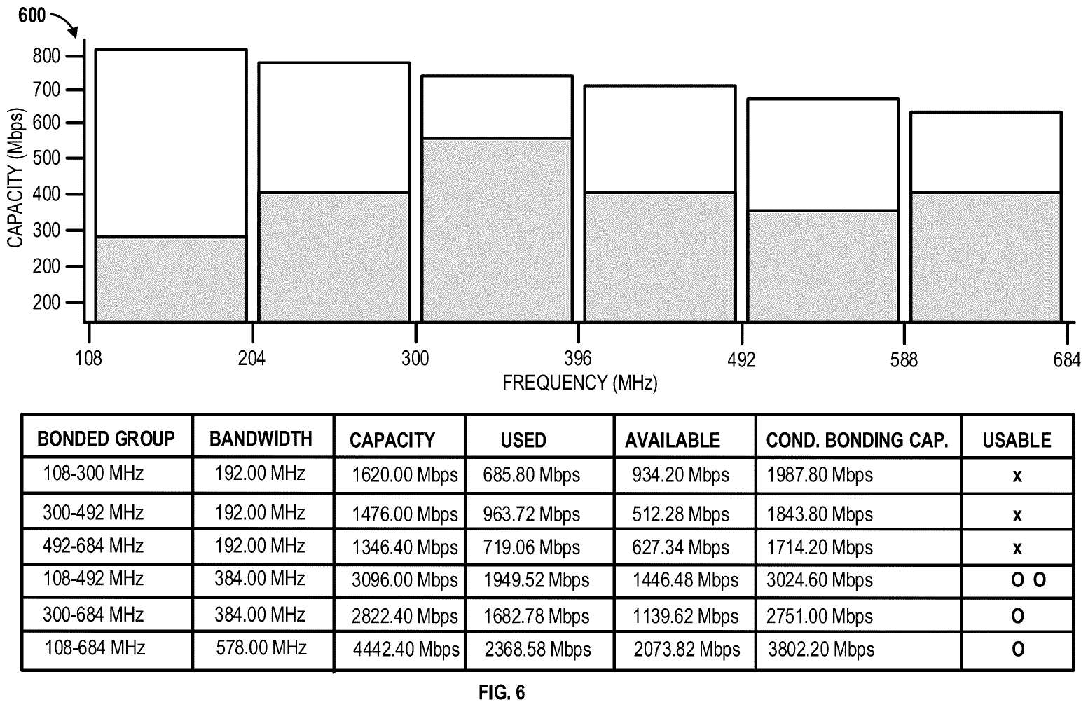

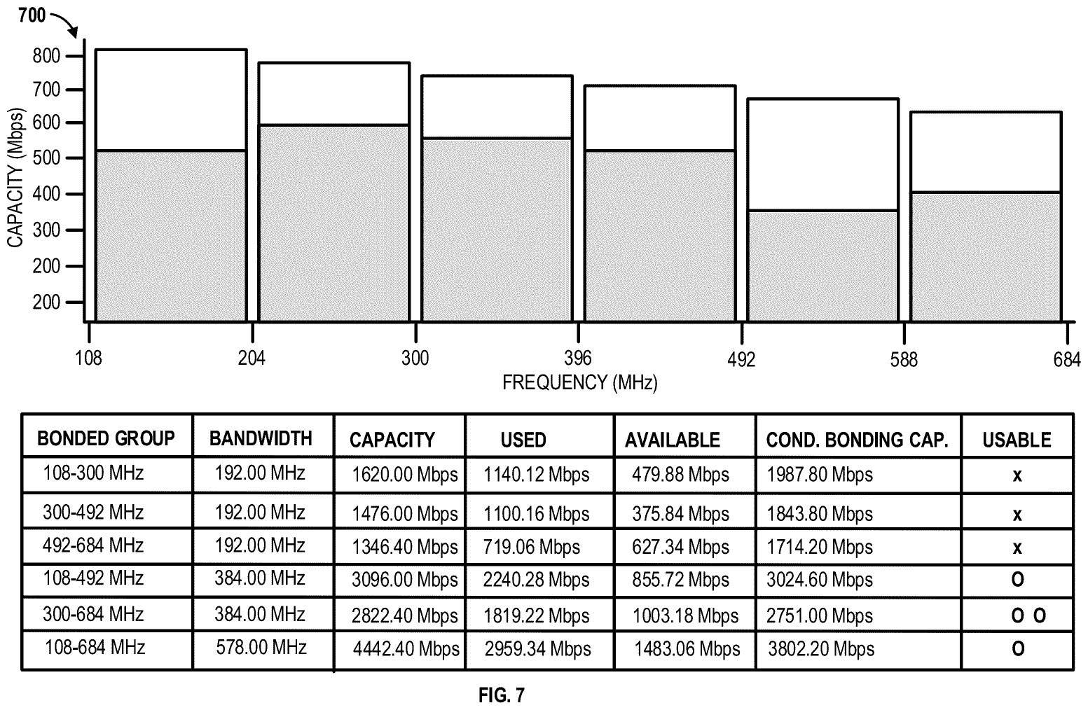

FIG. 5 shows an example bonding process 500 for determining the channels to include a channel bonding group. At 502, it may be determined whether a communication device's (e.g., network device 116, cable modem, gateway device, wireless access point, etc.) provisioning rates (e.g., service tier) have changed. For example, after determining/calculating a usable channel bonding group and utilization factors, one or more of the provisioning rates for one or more of the channels in the channel bonding may have changed. For example, a user may subscribe to a new service tier after the determination of the usable channel bonding group. Changes associated with the provisioning rates may cause changes associated with a capacity requirement of the channel bonding group (e.g., usable/candidate channel bonding groups' capacities need to meet the new rate requirements). If none of the provisioning rates have changed, the provisioning rates of the communication device are monitored until a change in one or more of the provisioning rates is detected. If one of the provisioning rates has changed, the provisioning rates of the channels of the channel bonding group may be determined at 504. At 506, policy configurations (e.g., traffic rate(s), margin(s), etc.) of the communication device may be determined. For example, the policy configurations may be associated with a layout of available channel bonding groups (e.g., bonding group size and ranges), an optional margin requirement for a channel bonding group's capacity, and a conditional bit-loading of each channel bonding group (e.g., bandwidth per Hz efficiency of each channel bonding group, etc.). At 508, the communication device provisioning rates and the communication device policy configurations may be analyzed to calculate/determine usable channel bonding groups and the channel bonding groups' utilization factors. For example, one or more combinations (e.g., configurations) of available channels (e.g., the channels shown in FIG. 2) may be analyzed to determine utilization factors, including mean bit-loadings, of each channel bonding group. As an example, the utilization factors may be calculated as a channel utilization impact of the communication device and bandwidth demand of each of the usable, or candidate, channel bonding groups based on the policy configurations. A bit-loading of a channel may represent an efficiency of a channel (e.g., N bits per symbol). For example, higher bit-loadings may indicate that each symbol may carry more information in the number of bits (e.g., going from 8 bits to 10 bits may result in a 25% increase in efficiency). Mean bit-loadings may be calculated from each subcarrier's bit-loading of all of the channels in a channel bonding group. Based on the utilization factors, one of the combinations of channels may be assigned to the channel bonding group for the communication device. In an example, as shown in FIG. 6, for a communication device subscribed to a 2.2 Gbps service, a plurality of channel combinations/configurations may be analyzed. For example, the utilization factors of each channel combination/configuration may be analyzed. As shown in FIG. 6, the first three channel combinations/configurations may be ruled out because the capacity of each of the channel combinations/configurations does not meet the 2.2 Gbps requirement. Furthermore, based on analyzing the utilization factors of each channel combination/configuration, the 108 MHZ to 492 MHz channel group may be assigned to the channel bonding group for the communication device because its conditional bonding capacity is greater than the requirement (2.2 Gbps), its number of channels (4 channels) is less than the largest bonding group with 6 channels, and its available capacity is higher than another 384 MHz bonding group covering 300 MHz to 684 MHz at the load balancing optimization time. At 510, one or more resources of the communication device may be allocated per channel of the combination/configuration of channels assigned to the channel bonding group at 508. The one or more resources may comprise one or more of power, computing resources, or data throughput. As an example, if multiple bonding groups prioritize the use of a first channel (e.g., a first frequency range), then the first channel may have a high utilization relative to the remaining channels (e.g., other frequency ranges). Load balancing may be applied to the bonding group in order to allocate the communication device's resources amongst the channels of the channel bonding group. Returning to 502, it may be determined whether the communication device's provisioning rates (e.g., service tier) have changed after the combination/configuration of channels are assigned to the communication device's channel bonding group and the communication device's resources are allocated amongst the channels in the channel bonding group. Steps 504-508 may be repeated based on the current channel bonding group. However, as an example, the 300-684 MHz channel combination/configuration may be assigned to the communication device's channel bonding group based on the new utilization factors, as shown in FIG. 7. For example, the 300-684 MHz channel combination/configuration available capacity increased, becoming higher than the first channel bonding group (100-492 MHZ).

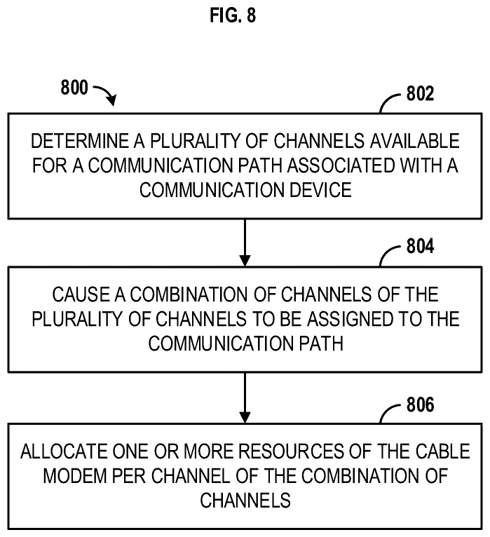

FIG. 8 shows a flowchart of an example method 800 for determining a combination of channels to be assigned to a channel bonding group. Method 800 may be implemented, for example, by a communication device (e.g., network device 116, cable modem, gateway device, wireless access point, etc.). At step 802, a plurality of channels available for a communication path associated with a communication device (e.g., network device 116, cable modem, gateway device, wireless access point, etc.) may be determined. The communication path may comprise an upstream communication path or a downstream communication path. The communication path may be associated with a channel bonding group. Each channel of the plurality of channels may comprise a frequency range of a plurality of frequency ranges.

At step 804, a combination of channels of the plurality of channels may be caused to be assigned to the communication path based on a capability of the communication device (e.g., network device 116, cable modem, gateway device, wireless access point, etc.) and user account information associated with the communication device. As an example, a maximum number of channels the communication device is capable of using may be determined and a minimum number of channels required to be used by the communication device to provide a throughput associated with a subscription level (e.g., service level such as 3 Gbps, 2 Gbps, 1 Gbps, etc.) associated with the user account information may be determined. The combination of channels of the plurality of channels may be caused to be assigned to the communication path based on the maximum number of channels and the minimum number of channels. For example, a ratio of a total power level capability of the communication device divided by target power levels per channel of the maximum number of channels may be determined. The combination of channels of the plurality of channels may be caused to be assigned to the communication path based on the ratio and based on the minimum number of channels.

At step 806, one or more resources of the communication device (e.g., network device 116, cable modem, gateway device, wireless access point, etc.) may be allocated per channel of the combination of channels. The one or more resources may comprise one or more of power, computing resources, or data throughput. For example, if multiple bonding groups prioritize the use of a first channel (e.g., a first frequency range), then the first channel may have a high utilization relative to the remaining channels (e.g., remaining frequency ranges). Load balancing may be applied to the combination of channels in order to allocate the communication device's resources amongst the channels of the combination of channels.

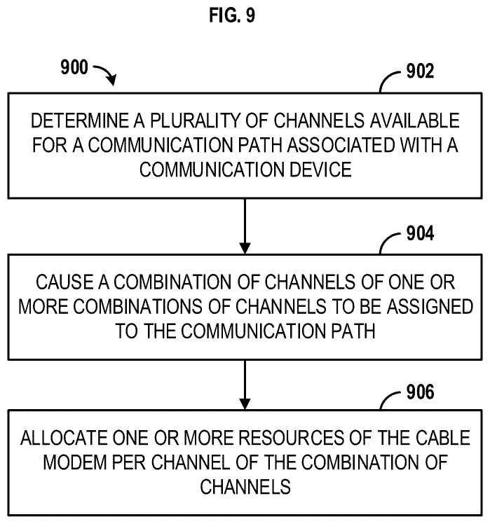

FIG. 9 shows a flowchart of an example method 900 for determining a combination of channels to be assigned to a channel bonding group. Method 900 may be implemented, for example, by a communication device (e.g., network device 116, cable modem, gateway device, wireless access point, etc.). At step 902, a plurality of channels available for a communication path associated with a communication device (e.g., network device 116, cable modem, gateway device, wireless access point, etc.) may be determined. The communication path may comprise an upstream communication path or a downstream communication path. The communication path may be associated with a channel bonding group. Each channel of the plurality of channels may comprise a frequency range of a plurality of frequency ranges.

At step 904, a combination of channels of one or more combinations of channels of the plurality of channels may be caused to be assigned to the communication path based on one or more characteristics associated with the one or more combinations of channels of the plurality of channels. For example, the communication device (e.g., network device 116, cable modem, gateway device, wireless access point, etc.) may cause the combination of channels of the one or more combinations of channels of the plurality of channels to be assigned to the communication path based on the one or more characteristics associated with the one or more combinations of channels of the plurality of channels. The one or more characteristics associated with the one or more combinations of channels may comprise one or more of a number of channels, a bandwidth, a maximum capacity, capacity usage, an available capacity, or a conditional bonding capacity. In an example, a required capacity for the communication path may be determined based on user account information associated with the communication device and the one or more combinations of channels of the plurality of channels may be initially determined. For example, one or more users of the communication device may be subscribed to one or more service tiers (e.g., service level such as 3 Gbps, 2 Gbps, 1 Gbps, etc.) for transferring data between the communication device and the headend. The service tier associated with the communication device may be determined based on the user account information associated with the communication device. In addition, the communication device may determine a combination of channels associated with the 108-300 MHz frequency range, the 300-492 MHz frequency range, the 300-684 MHz frequency range, etc. The communication device may determine one or more characteristics for each combination of channels of the one or more combinations of channels. Based on the required capacity for the communication path and based on the one or more characteristics associated with the one or more combinations of channels, the communication device may cause the combination of channels of the one or more combinations of channels to be assigned to the communication path.

As an example, each combination of channels may at least comprise a total capacity that may be compared to the required capacity for the communication path. Each combination of channels that does not have a total capacity that is equal to, or greater than, the required capacity may not need to be considered. The communication device may determine the combination of channels from the remaining combinations of channels based on one or more of the other characteristics. For example, the remaining characteristics may be considered (e.g., weighted) based on one or more metrics. The one or more metrics may be optimized for upstream or downstream communication from the communication device to the headend. In one example, computing overhead and/or performance may be optimized for upstream communication network from the communication device to the headend. The combination of channels may be further determined based on one or more characteristics that best optimize computing overhead and/or performance for upstream communications. In another example, received power at the communication device may be optimized for downstream communication network from the headend to the communication device. The combination of channels may be further determined based on one or more characteristics that best optimize received power for downstream communications.

At step 906, one or more resources of the communication device (e.g., network device 116, cable modem, gateway device, wireless access point, etc.) may be allocated per channel of the combination of channels. The one or more resources may comprise one or more of power, computing resources, or data throughput. For example, if multiple bonding groups prioritize the use of a first channel (e.g., a first frequency range), then the first channel may have a high utilization relative to the remaining channels. Load balancing may be applied to the combination of channels in order to allocate the communication device's resources amongst the channels of the combination of channels.

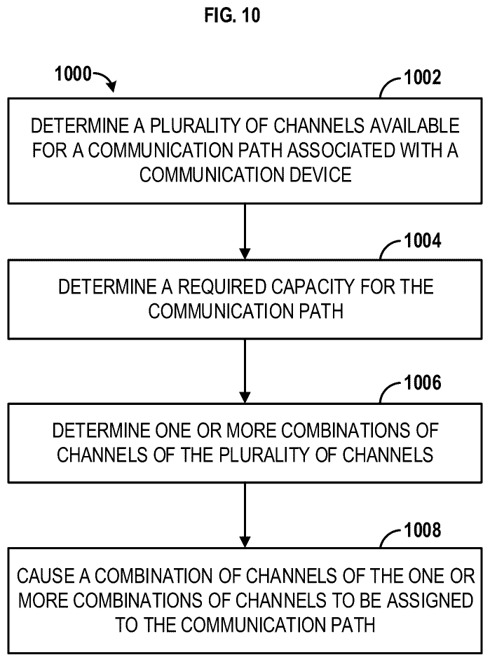

FIG. 10 shows a flowchart of an example method 1000 for determining a combination of channels to be assigned to a channel bonding group. Method 1000 may be implemented, for example, by a communication device (e e.g., network device 116, cable modem, gateway device, wireless access point, etc.). At step 1002, a plurality of channels available for a communication path associated with a communication device (e e.g., network device 116, cable modem, gateway device, wireless access point, etc.) may be determined. The communication path may comprise an upstream communication path or a downstream communication path. The communication path may be associated with a channel bonding group. Each channel of the plurality of channels may comprise a frequency range of a plurality of frequency ranges.

At step 1004, a required capacity for the communication path may be determined based on user account information associated with the communication device (e e.g., network device 116, cable modem, gateway device, wireless access point, etc.). For example, one or more users of the communication device may be subscribed to one or more service tiers (e.g., service level such as 3 Gbps, 2 Gbps, 1 Gbps, etc.) for transferring data between the communication device and the headend. The service tier associated with the communication device may be determined based on the user account information associated with the communication device.

At step 1006, one or more combinations of channels of the plurality of channels may be determined. For example, the communication device (e.g., network device 116, cable modem, gateway device, wireless access point, etc.) may determine the one or more combinations of channels of the plurality of channels. For example, the communication device may determine a combination of channels associated with the 108-300 MHz range, the 300-492 MHz range, the 300-684 MHz frequency range, etc. that may be available to the communication device.

At step 1008, a combination of channels of the one or more combinations of channels may be caused to be assigned to the communication path based on the required capacity for the communication path and based on one or more characteristics associated with each combination of channels of the one or more combinations of channels. For example, the communication device (e.g., network device 116, cable modem, gateway device, wireless access point, etc.) may cause the combination of channels of the one or more combinations of channels to be assigned to the communication path based on the required capacity for the communication path and based on the one or more characteristics associated with each combination of channels of the one or more combinations of channels. As an example, the communication device may determine one or more characteristics for each combination of channels of the one or more combinations of channels. The one or more characteristics associated with the one or more combinations of channels may comprise one or more of a number of channels, a bandwidth, a maximum capacity, capacity usage, an available capacity, or a conditional bonding capacity.

As an example, each combination of channels may at least comprise a total capacity that may be compared to the required capacity for the communication path. Each combination of channels that does not have a total capacity that is equal to, or greater than, the required capacity may not need to be considered. The communication device may determine the combination of channels from the remaining combinations of channels based on one or more of the other characteristics. For example, the remaining characteristics may be considered (e.g., weighted) based on one or more metrics. The one or more metrics may be optimized for upstream communication from the communication device to the headend. In one example, computing overhead and/or performance may be optimized for upstream communication network from the communication device to the headend. The combination of channels may be further determined based on one or more characteristics that best optimize computing overhead and/or performance for upstream communications. In another example, received power at the communication device may be optimized for downstream communication network from the headend to the communication device. The combination of channels may be further determined based on one or more characteristics that best optimize received power for downstream communications.

In an example, one or more resources of the communication device may be allocated per channel of the combination of channels. The one or more resources may comprise one or more of power, computing resources, or data throughput. For example, if multiple bonding groups prioritize the use of a first channel (e.g., a first frequency range), then the first channel may have a high utilization relative to the remaining channels. Load balancing may be applied to the combination of channels in order to allocate the communication device's resources amongst the channels of the combination of channels.

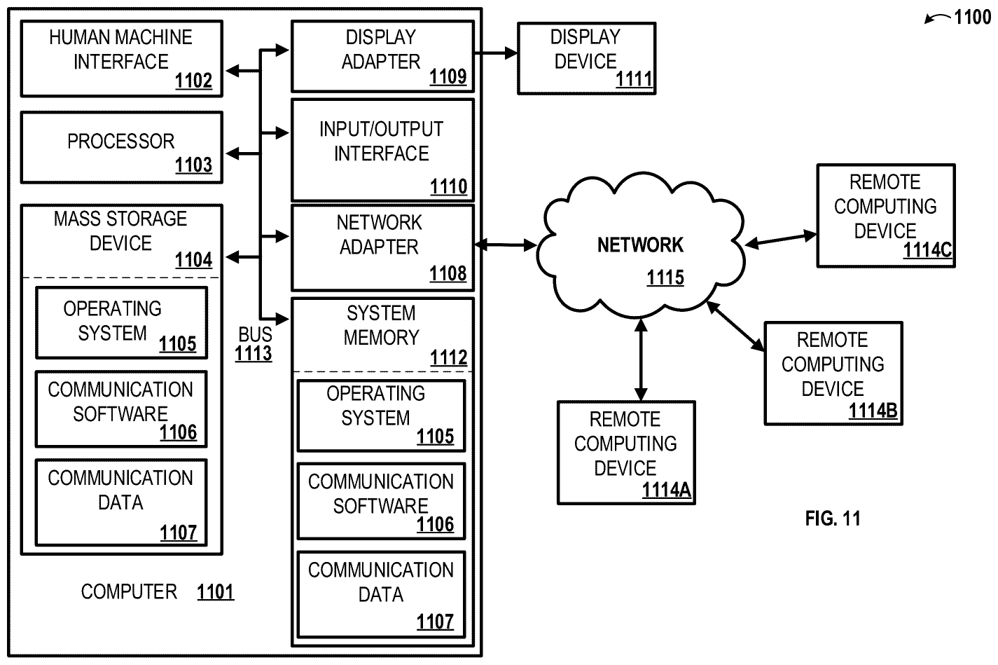

FIG. 11 is a block diagram illustrating an example computing device. The methods and systems can be implemented on a computer 1101 as illustrated in FIG. 11 and described below. By way of example, the device 102, the network device 116, and the computing device 104 of FIG. 1 can be a computer 1101 as illustrated in FIG. 11. Similarly, the methods and systems disclosed can utilize one or more computers to perform one or more functions in one or more locations. FIG. 11 is a block diagram illustrating an exemplary operating environment 1100 for performing the disclosed methods. This exemplary operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the exemplary operating environment 1100.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1101. The computer 1101 can comprise one or more components, such as one or more processors 1103, a system memory 1112, and a bus 1113 that couples various components of the computer 1101 including the one or more processors 1103 to the system memory 1112. In the case of multiple processors 1103, the system can utilize parallel computing.

The bus 1113 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and one or more of the components of the computer 1101, such as the one or more processors 1103, a mass storage device 1104, an operating system 1105, communication software 1106, communication data 1107, a network adapter 1108, system memory 1112, an Input/Output Interface 1110, a display adapter 1109, a display device 1111, and a human machine interface 1102, can be contained within one or more remote computing devices 1114A-1114C at physically separate locations, connected through buses of this form, in effect implementing a fully distributed system.

The computer 1101 typically comprises a variety of computer readable media. Exemplary readable media can be any available media that is accessible by the computer 1101 and comprises, for example and not meant to be limiting, both volatile and non-volatile media, removable and non-removable media. The system memory 1112 can comprise computer readable media in the form of volatile memory, such as random access memory (RAM), and/or non-volatile memory, such as read only memory (ROM). The system memory 1112 typically can comprise data such as communication data 1107 and/or program modules such as operating system 1105 and communication software 1106 that are accessible to and/or are operated on by the one or more processors 1103.

The computer 1101 can also comprise other removable/non-removable, volatile/non-volatile computer storage media. By way of example, the computer 1101 can comprise a mass storage device 1104 which can offer non-volatile storage of computer code, computer readable instructions, data structures, program modules, and other data for the computer 1101. For example, a mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, including by way of example, an operating system 1105 and communication software 1106. One or more of the operating system 1105 and communication software 1106 (or some combination thereof) can comprise elements of the programming and the communication software 1106. Communication data 1107 can also be stored on the mass storage device 1104. Communication data 1107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1115.

The user can enter commands and information into the computer 1101 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1103 via a human machine interface 1102 that is coupled to the bus 1113, but can be connected by other interface and bus structures, such as a parallel port, game port, an IEEE 1394 Port (also known as a Firewire port), a serial port, network adapter 1108, and/or a universal serial bus (USB).

A display device 1111 can also be connected to the bus 1113 via an interface, such as a display adapter 1109. It is contemplated that the computer 1101 can have more than one display adapter 1109 and the computer 1101 can have more than one display device 1111. For example, a display device 1111 can be a monitor, an LCD (Liquid Crystal Display), light emitting diode (LED) display, television, smart lens, smart glass, and/or a projector. In addition to the display device 1111, other output peripheral devices can comprise components such as speakers (not shown) and a printer (not shown) which can be connected to the computer 1101 via Input/Output Interface 1110. Any step and/or result of the methods can be output in any form to an output device. Such output can be any form of visual representation, including, but not limited to, textual, graphical, animation, audio, tactile, and the like. The display 1111 and computer 1101 can be part of one device, or separate devices.

The computer 1101 can operate in a networked environment using logical connections to one or more remote computing devices 1114A, 1114B, and 1114C. By way of example, a remote computing device 1114A-1114C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1101 and a remote computing device 1114A-1114C can be made via a network 1115, such as a local area network (LAN) and/or a general wide area network (WAN). Such network connections can be through a network adapter 1108. A network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components can reside at various times in different storage components of the computer 1101, and are executed by the one or more processors 1103 of the computer 1101. An implementation of communication software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining a plurality of channels available for a communication path associated with a communication device;
causing, based on a capability of the communication device and user account information associated with the communication device, a combination of channels of the plurality of channels to be assigned to the communication path; and
allocating one or more resources of the communication device per channel of the combination of channels.

2. The method of claim 1, wherein the communication path comprises an upstream communication path or a downstream communication path.

3. The method of claim 1, wherein the communication path is associated with a channel bonding group.

4. The method of claim 1, wherein each channel of the plurality of channels comprises a frequency range of a plurality of frequency ranges.

5. The method of claim 1, wherein causing, based on the capability of the communication device and the user account information associated with the communication device, the combination of channels of the plurality of channels to be assigned to the communication path comprises:
determining a maximum number of channels the communication device is capable of using;
determining a minimum number of channels required to be used by the communication device to provide a throughput associated with a subscription level associated with the user account information; and
causing, based on the maximum number of channels and the minimum number of channels, the combination of channels of the plurality of channels to be assigned to the communication path.

6. The method of claim 5, wherein causing, based on the maximum number of channels and the minimum number of channels, the combination of channels of the plurality of channels to be assigned to the communication path comprises:
determining a ratio of a total power level capability of the communication device divided by target power levels per channel of the maximum number of channels; and
causing, based on the ratio and based on the minimum number of channels, the combination of channels of the plurality of channels to be assigned to the communication path.

7. The method of claim 1, wherein the one or more resources comprise one or more of power, computing resources, or data throughput.

8. A method comprising:
determining, by a device, a plurality of channels available for a communication path associated with a communication device;
causing, based on one or more characteristics associated with one or more combinations of channels of the plurality of channels, a combination of channels of the one or more combinations of channels to be assigned to the communication path; and
allocating one or more resources of the communication device per channel of the combination of channels.

9. The method of claim 8, wherein the communication path comprises an upstream communication path or a downstream communication path.

10. The method of claim 8, wherein the communication path is associated with a channel bonding group.

11. The method of claim 8, wherein each channel of the plurality of channels comprises a frequency range of a plurality of frequency ranges.

12. The method of claim 8, wherein the one or more characteristics associated with the one or more combinations of channels comprise one or more of a number of channels, a bandwidth, a maximum capacity, capacity usage, an available capacity, or a conditional bonding capacity.

13. The method of claim 8, wherein causing, based on the one or more characteristics associated with the one or more combinations of channels of the plurality of channels, the combination of channels of the one or more combinations of channels to be assigned to the communication path comprises:
determining, based on user account information associated with the communication device, a required capacity for the communication path;
determining the one or more combinations of channels of the plurality of channels; and
causing, based on the required capacity for the communication path and based on the one or more characteristics associated with the one or more combinations of channels, the combination of channels of the one or more combinations of channels to be assigned to the communication path.

14. The method of claim 8, wherein the one or more resources comprise one or more of power, computing resources, or data throughput.

15. A method comprising:
determining, by a device, a plurality of channels available for a communication path associated with a communication device;
determining, based on user account information associated with the communication device, a required capacity for the communication path;
determining one or more combinations of channels of the plurality of channels; and
causing, based on the required capacity for the communication path and based on one or more characteristics associated with each combination of channels of the one or more combinations of channels, a combination of channels of the one or more combinations of channels to be assigned to the communication path.

16. The method of claim 15, wherein the communication path comprises an upstream communication path or a downstream communication path.

17. The method of claim 15, wherein the communication path is associated with a channel bonding group.

18. The method of claim 15, wherein each channel of the plurality of channels comprises a frequency range of a plurality of frequency ranges.

19. The method of claim 15, further comprising allocating one or more resources of the communication device per channel of the combination of channels.

20. The method of claim 19, wherein the one or more resources comprise one or more of power, computing resources, or data throughput.
